(19) United States
(12) Patent Application Publication
(10) Pub. No.: US 2023/0076217 A1
(43) Pub. Date: Mar. 9, 2023

(54) FORM CREATING SYSTEM AND NON-TRANSITORY COMPUTER READABLE MEDIUM

(71) Applicant: FUJIFILM Business Innovation Corp., Tokyo (JP)

(72) Inventor: Futoshi OTAKA, Kanagawa (JP)

(73) Assignee: FUJIFILM Business Innovation Corp., Tokyo (JP)

(21) Appl. No.: 17/705,363

(22) Filed: Mar. 27, 2022

(30) Foreign Application Priority Data
Sep. 9, 2021 (JP) 2021-146746

(51) Int. Cl. G06F 40/174; H04L 67/52; H04N 1/00; G06K 7/14

(52) U.S. Cl. CPC G06F 40/174; H04L 67/18; H04N 1/00095; G06K 7/1417

(57) ABSTRACT

A form creating system includes a terminal apparatus that creates a form; and a server that receives transmission of the form from the terminal apparatus. The server transmits, to the terminal apparatus, format data of the form to which item data indicative of a necessary entry item of information concerning a user is added in response to a request from the terminal apparatus, and the terminal apparatus stores the information concerning the user in a storage device of the terminal apparatus in association with the item data, creates the form by entering, in an entry field associated with the item data in the format data, information corresponding to the item data added to the format data received from the server among the information concerning the user stored in the terminal apparatus, and transmits the created form to the server.

### CROSS-REFERENCE TO RELATED APPLICATIONS

This application is based on and claims priority under 35 USC 119 from Japanese Patent Application No. 2021-146746 filed Sep. 9, 2021.

### BACKGROUND

### (i) Technical Field

The present disclosure relates to a form creating system and a non-transitory computer readable medium.

### (ii) Related Art

Those who use service such as public service or private service are often required to fill in a form such as an application form. Such forms typically have various formats but require entry of common information such as information concerning an applicant. In view of this, information is automatically entered in accordance with a format of a form by using an electronic information device.

Japanese Unexamined Patent Application Publication No. 2006-221493 discloses a system including a database that is provided on a user assistance server side and stores therein personal information, application basic information, and application history information, which are original information entered in a partner designated form format, and the user assistance server having a function of displaying, for a client, an application screen on which application can be made in a universal format independent of the partner designated form, a function of storing the partner designated form format in the user assistance server, means for associating the information stored in the database with the partner designated form format stored in the user assistance server, means for outputting the partner designated form, and a function of transmitting an application notification e-mail for confirmation of an application after a desired time based on the application information stored in the database to an applicant.

### SUMMARY

Information which an applicant is required to enter in a form such as an application form typically includes personal information such as information concerning an applicant's name and contact information. As for such personal information, it is sometimes desired that only information necessary according to a format of a form to be created can be presented.

Aspects of non-limiting embodiments of the present disclosure relate to a form creating system that presents only information necessary according to a format of a form to be created among personal information such as information concerning an applicant when the form is created.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a form creating system including a terminal apparatus that creates a form; and a server that receives transmission of the form from the terminal apparatus, wherein the server transmits, to the terminal apparatus, format data of the form to which item data indicative of a necessary entry item of information concerning a user is added in response to a request from the terminal apparatus, and the terminal apparatus stores the information concerning the user in a storage device of the terminal apparatus in association with the item data, creates the form by entering, in an entry field associated with the item data in the format data, information corresponding to the item data added to the format data received from the server among the information concerning the user stored in the terminal apparatus, and transmits the created form to the server.

### BRIEF DESCRIPTION OF THE DRAWINGS

Exemplary embodiments of the present disclosure will be described in detail based on the following figures, wherein:

FIG. 1 illustrates a configuration of a form creating system to which the first exemplary embodiment is applied;

FIG. 2 illustrates an example of a hardware configuration of a terminal apparatus;

FIG. 3 illustrates a functional configuration of the terminal apparatus;

FIG. 4 illustrates a configuration of the form creating server;

FIG. 5 illustrates a display example of a form;

FIG. 6 illustrates an example of information managed by a user information managing function of the terminal apparatus;

FIG. 7 illustrates an example of a registration screen for registration of information concerning a user;

FIG. 8 is a flowchart illustrating how the terminal apparatus operates when a form is created;

FIG. 9 is a flowchart illustrating how the form creating server operates when a form is created;

FIG. 10 is a flowchart illustrating how the form creating server operates when item data is registered;

FIG. 11 illustrates a functional configuration of a terminal apparatus;

FIG. 12 illustrates a configuration of a form creating server;

FIG. 13 is a flowchart illustrating how the terminal apparatus operates when information for form is created; and

FIG. 14 is a flowchart illustrating how the form creating server operates when a form is created.

### DETAILED DESCRIPTION

Exemplary embodiments of the present disclosure are described in detail below with reference to the attached drawings.

### First Exemplary Embodiment

### System Configuration

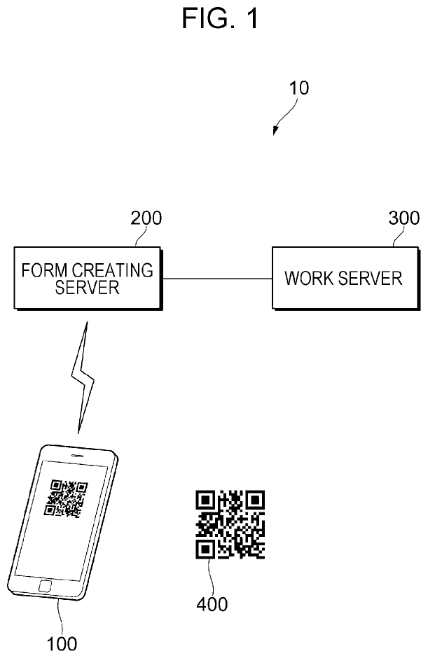

FIG. 1 illustrates a configuration of a form creating system to which a first exemplary embodiment is applied. A form creating system 10 according to the first exemplary embodiment includes a terminal apparatus 100, a form creating server 200, and a work server 300. In the first exemplary embodiment, form data is created in the terminal apparatus 100. Specifically, a blank form is sent from the form creating server 200 to the terminal apparatus 100, and a form is created by entering information in the blank form in the terminal apparatus 100.

The terminal apparatus 100 is an information processing apparatus which a creator of a form uses. The terminal apparatus 100 is, for example, a mobile information processing apparatus such as a smartphone or a tablet PC or a personal computer. The terminal apparatus 100 connects to the form creating server 200 over a network and acquires a blank form from the form creating server 200. The terminal apparatus 100 transmits data of a created form to the form creating server 200 over the network.

The terminal apparatus 100 may have a function of reading a code image 400. The code image 400 records code information thereon. The code information includes connection information for connection to the form creating server 200 and identification information for identifying that the code information is information obtained by reading the code image 400. The terminal apparatus 100 reads the code image 400, connects to the form creating server 200 on the basis of obtained connection information, and transmits identification information obtained by reading the code image 400 to the form creating server 200. This allows the terminal apparatus 100 to notify the form creating server 200 that the terminal apparatus 100 has connected to the form creating server 200 by reading the code image 400.

Any of various existing images can be used as the code image 400. For example, the code image 400 may be a two-dimensional code such as a QR code (Registered Trademark) or may be a bar code. As the connection information, a uniform resource locator (UERL) of the form creating server 200 may be written in a text. Furthermore, both of the URL of the form creating server 200 and identification information may be written in a text. In a case where the code information is written in a text, the terminal apparatus 100 reads the code information, for example, by performing analysis processing such as Optical Character Recognition (OCR) on an image including a text photographed by a camera.

In the present exemplary embodiment, the code image 400 is placed at a specific place. The specific place means that a place where the terminal apparatus 100 has connected to the form creating server 200 is specified. As described above, the code image 400 records connection information thereon, and the terminal apparatus 100 can connect to the form creating server 200 by using the connection information. Furthermore, the code image 400 records identification information thereon, and the code image 400 used by the terminal apparatus 100 to connect to the form creating server 200 can be specified by using the identification information. Accordingly, by placing the code image 400 at a specific place, the form creating server 200 can specify a place where the terminal apparatus 100 has connected to the form creating server 200 on the basis of identification information included in code information acquired from the terminal apparatus 100 in a case where the terminal apparatus 100 connects to the form creating server 200 by using the code information read from the code image 400.

The place where the code image 400 is placed is, for example, a place where service using a form created by the form creating system 10 is offered. For example, assume that the form creating system 10 is applied to reception work for receiving submission of a form such as an application form. In this case, it is assumed that in a case where a form is created near a reception desk, the created form is immediately submitted to the reception desk. Meanwhile, it is assumed that in a case where a form is created in a place other than the reception desk, the created form is submitted when a user visits the reception desk after forming the form. In view of this, by placing the code image 400 near the reception desk, it is determined whether or not the terminal apparatus 100 has connected to the form creating server 200 near the reception desk on the basis of whether or not the terminal apparatus 100 has connected to the form creating server 200 by using the code image 400. In a case where the terminal apparatus 100 has connected to the form creating server 200 near the reception window, the form created by the terminal apparatus 100 is immediately transmitted to the form creating server 200 and is subjected to reception work. Meanwhile, in a case where the terminal apparatus 100 has connected to the form creating server 200 in a place other than the reception desk, the form created by the terminal apparatus 100 is stored in the terminal apparatus 100 without being transmitted to the form creating server 200. Then, when the terminal apparatus 100 connects to the form creating server 200 again near the reception desk, the form stored in the terminal apparatus 100 is transmitted to the form creating server 200 and is subjected to reception work. Note that the example of application to the reception work is merely an example of application of the present exemplary embodiment. The present exemplary embodiment is applicable to various systems in which different operations are performed on a created form depending on whether or not the terminal apparatus 100 has connected to the form creating server 200 by using the code image 400.

In a case where the code image 400 is used for the above purpose, identification information of the code image 400 may be one for identifying a place where the code image 400 is placed instead of one for identifying the individual code image 400. In the example of application to the reception work, for example, plural code images 400 may be placed near the reception desk, and common identification information indicating that these code images 400 are placed near the reception desk may be recorded on these code images 400. This also allows the form creating server 200 to specify that connection has been made near the reception desk in a case where a user connects the terminal apparatus 100 to the form creating server 200 by using any of these code images 400 placed near the reception desk.

The terminal apparatus 100 may use a wireless line or may use a wired line to connect to the network. Although the terminal apparatus 100 and the form creating server 200 are connected by a wireless line in the example illustrated in FIG. 1, the configuration illustrated in FIG. 1 is not restrictive. For example, as illustrated in FIG. 1, in a case where the terminal apparatus 100 is a smartphone, the terminal apparatus 100 may connect to the network through wireless data communication. Meanwhile, in a case where the terminal apparatus 100 is a personal computer, the terminal apparatus 100 may be connected to the network by using a local arear network (LAN) cable.

The form creating server 200 is a server that assists creation of a form in the form creating system 10. Specifically, the form creating server 200 transmits data of a blank form to the terminal apparatus 100 in response to a request from the terminal apparatus 100 and receives data of a form created in the terminal apparatus 100. The form creating server 200 is a server provided on the network and may be realized by a single server machine or may be realized by a virtual server or a cloud server in which functions as the form creating server 200, which will be described later, are realized by plural servers.

The work server 300 is a server used for work using a created form. The work server 300 acquires a created form from the form creating server 200, receives an operation by a person in charge of the work, and performs processing on the form in accordance with the received operation. The kind of work using a form is not limited in particular. The work using a form is, for example, reception work for receiving an application form or a registration form as an example of a form. The work server 300 is a server provided on the network and may be realized by a single server machine or may be realized by a virtual server or a cloud server in which functions as the work server 300 are realized by plural servers. Although the form creating server 200 and the work server 300 are separate servers in the example of the configuration illustrated in FIG. 1, a single server that has the functions of the form creating server 200 and the functions of the work server 300 may be provided.

### Hardware Configuration of Terminal Apparatus 100

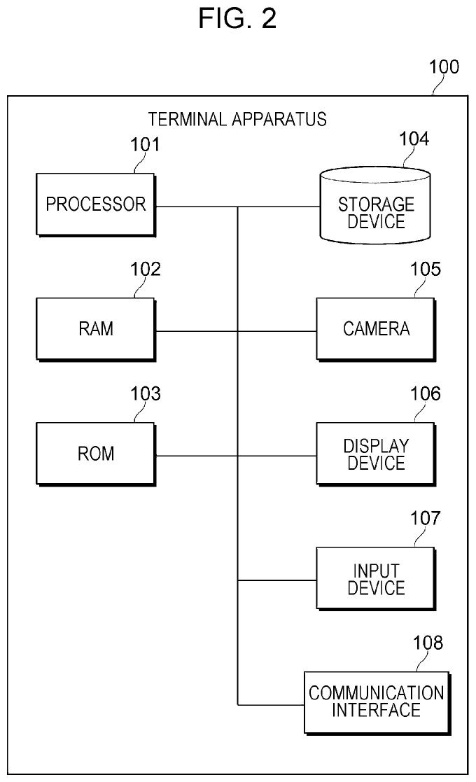

FIG. 2 illustrates an example of a hardware configuration of the terminal apparatus 100. The terminal apparatus 100 is, for example, a computer and includes a processor 101, a random access memory (RAM) 102, a read only memory (ROM) 103, a storage device 104, a camera 105, a display device 106, an input device 107, and a communication interface 108.

The processor 101 is a computing device and performs various kinds of processing and control by executing programs. The RAM 102 is a main storage device (main memory) and is used as a working memory while arithmetic processing is performed by the processor 101. The ROM 103 holds therein data such as a program and setting values prepared in advance, and the processor 101 can perform processing by reading a program and data directly from the ROM 103.

The storage device 104 is a unit in which a program and data are stored. A program is stored in the storage device 104, and the processor 101 executes the program stored in the storage device 104 by loading the program to the main storage device. Furthermore, a result of processing performed by the processor 101 is stored in the storage device 104. Specifically, form data created in the terminal apparatus 100 is stored in the storage device 104. Furthermore, information concerning a user of the terminal apparatus 100 is stored in the storage device 104. The information concerning the user is used for creation of form data. The storage device 104 is, for example, a magnetic disc device or a solid state drive (SSD).

The camera 105 is a photographing device for acquiring image data. The camera 105 is used to photograph the code image 400 in a case where the terminal apparatus 100 connects to the form creating server 200 by using information recorded on the code image 400 as illustrated in FIG. 1. Note that the camera 105 need not necessarily be provided in the terminal apparatus 100. For example, a digital camera that is an external device that can transmit image data to the terminal apparatus 100 may be connected to the terminal apparatus 100 as a unit for acquiring the code image 400 instead of the camera 105 of the terminal apparatus 100.

The display device 106 is a device that displays an image or a document for a user of the terminal apparatus 100. The display device 106 displays a form based on format data acquired from the form creating server 200 and information entered by the user when a form is created in the terminal apparatus 100. The display device 106 is, for example, a liquid crystal display or an organic Electro-Luminescence (EL) display.

The input device 107 is a device used to enter data or a command by the user of the terminal apparatus 100. The input device 107 is used to enter information in a form in a case where a form is created in the terminal apparatus 100. The input device 107 is, for example, a keyboard, a pointing device, or a touch sensor. A touch sensor serving as the input device 107 may be superimposed on a display screen of the display device 106 to constitute a touch panel. The input device 107 is an example of an input unit.

The communication interface 108 is a connection unit for connecting to the form creating server 200 over the network. The communication interface 108 is a device that varies depending on the network to which the terminal apparatus 100 is connected and the kind of line. For example, in a case where the communication interface 108 is connected to the network through a wired line, a network adapter corresponding to the used line is used as the communication interface 108. Meanwhile, in a case where the communication interface 108 is connected to the network through a wireless line, a wireless device is used as the communication interface 108.

### Functional Configuration of Terminal Apparatus 100

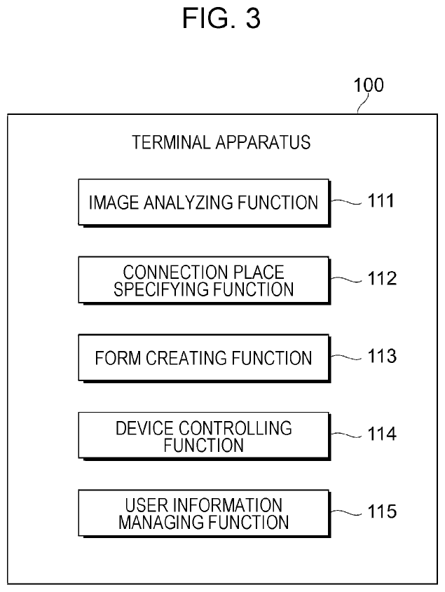

FIG. 3 illustrates a functional configuration of the terminal apparatus 100. The processor 101 illustrated in FIG. 2 executes programs, and thus the terminal apparatus 100 realizes an image analyzing function 111, a connection place specifying function 112, a form creating function 113, a device controlling function 114, and a user information managing function 115. The programs realizing the functions of the terminal apparatus 100 are, for example, stored in the ROM 103 or the storage device 104 illustrated in FIG. 2.

The image analyzing function 111 is a function of analyzing the code image 400 acquired, for example, by the camera 105. The terminal apparatus 100 reads connection information and identification information recorded on the code image 400 by the image analyzing function 111. The image analyzing function 111 and the camera 105 are an example of a reading unit that reads code information recorded on the code image 400.

The connection place specifying function 112 is a function of specifying a place where the terminal apparatus 100 has connected to the form creating server 200. The place means a place where the terminal apparatus 100 physically exists. The connection place may be specified by using any of various existing methods and is not limited in particular. For example, a satellite positioning system, an indoor positioning system using a radio wave or a sound wave, or the like may be used. Alternatively, information indicative of a place may be recorded on the code image 400, and the information indicative of the place may be extracted from code information read by the image analyzing function 111. Alternatively, a database in which identification information recorded on the code image 400 and information on a place where the code image 400 is provided are registered in association with each other may be prepared, and the information on the place may be acquired by making an inquiry to the database by using the identification information as a search key. In this case, the database may be, for example, provided on the network as a server to which the terminal apparatus 100 can connect, as with the form creating server 200. Alternatively, the database may be provided in the form creating server 200.

The form creating function 113 is a function of creating a form by using a blank form acquired from the form creating server 200. The terminal apparatus 100 acquires format data and item data of a form from the form creating server 200 by the form creating function 113. The format data is data recording a format of the form, and the item data is data indicative of an item (hereinafter referred to as an “entry item”) for which entry of information into the form is needed. The terminal apparatus 100 acquires information corresponding to items of the item data, for example, from the storage device 104 illustrated in FIG. 2 and creates a form by entering the acquired information in the format data. Among the entry items of the form, information is entered only for an item for which corresponding information is stored in the storage device 104, and information is not entered for an item for which corresponding information is not stored in the storage device 104.

Furthermore, the terminal apparatus 100 causes the form based on the format data to be displayed, for example, on the display device 106 illustrated in FIG. 2 by the form creating function 113. In a case where there is an item for which information acquired from the storage device 104 has been entered, the form is displayed in a manner such that the information has been entered in the corresponding item. A user of the terminal apparatus 100 can enter information for an item for which no information has been entered while referring to the displayed form. The terminal apparatus 100 receives the entry of the information and writes the entered information into the form by the form creating function 113. Then, the terminal apparatus 100 causes the created form to be stored, for example, in the storage device 104 illustrated in FIG. 2. In a case where a predetermined transmission condition is met, the terminal apparatus 100 transmits the created form to the form creating server 200. The transmission condition will be described later.

The device controlling function 114 is a function of controlling devices provided in the terminal apparatus 100. Specifically, the device controlling function 114 controls operation of devices such as the storage device 104, the camera 105, the display device 106, the input device 107, and the communication interface 108 illustrated in FIG. 2. In this way, write and read of data into and from the storage device 104, photographing using the camera 105, displaying on the display device 106, receipt of entry by operation of the input device 107, transmission and reception of data using the communication interface 108, and the like are performed. Although the control on the devices have been described collectively as a single function, driver programs for controlling the devices are typically prepared for the respective devices. Furthermore, processors that control the devices may be provided individually for the devices.

The user information managing function 115 is a function of managing information concerning the user. The information concerning the user includes, for example, private information and information indicative of attributes of the user. Specific examples thereof include information on a name, a date of birth, an address, a telephone number, an e-mail address, and a name of an organization to which the user belongs. Furthermore, the information concerning the user may include not only information concerning the user himself or herself but also information concerning a person having a specific relationship with the user. For example, the information concerning the user may include information such as a name of a family member of the user or a name of another member belonging to the same organization as the user. The user information managing function 115 causes names of these items and information concerning the user corresponding to the items to be stored and managed, for example, in the storage device 104 illustrated in FIG. 2 in association with each other. Many of information that needs to be entered in a form is information concerning a creator of the form. Therefore, by storing information concerning the user of the terminal apparatus 100 in advance, corresponding information can be acquired and automatically entered when a form is created by the form creating function 113.

Note that information managed by the user information managing function 115 does not necessarily correspond to information that need to be entered in a form. It is assumed that the form creating system 10 supports various kinds of forms. In this case, information that need to be entered may vary depending on the kind of form. Accordingly, not all pieces of information that need to be entered in a form need be managed by the user information managing function 115, and information other than information that need to be entered in a form may be managed by the user information managing function 115.

### Configuration of Form Creating Server 200

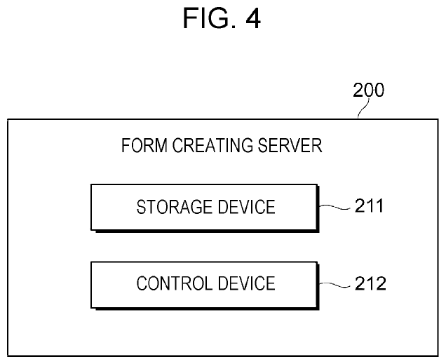

FIG. 4 illustrates a configuration of the form creating server 200. The form creating server 200 includes a storage device 211 and a control device 212. Although these devices are described as devices that constitute the single form creating server 200, the form creating server 200 may be a virtual server or the like realized by plural servers, and the storage device 211 and the control device 212 may be realized by different servers.

The storage device 211 is a device in which data concerning a form is stored. Specifically, the storage device 211 stores therein format data of a form and item data for specifying an item for which information is to be entered in the form.

The control device 212 reads out format data and item data of a form from the storage device 211 upon receipt of a request from the terminal apparatus 100 and transmits the format data and the item data to the terminal apparatus 100. Furthermore, the control device 212 receives data of a created form from the terminal apparatus 100 and transmits the received form data to the work server 300. The control device 212 may cause the form data received from the terminal apparatus 100 to be stored in the storage device 211.

### Example of Format of Form

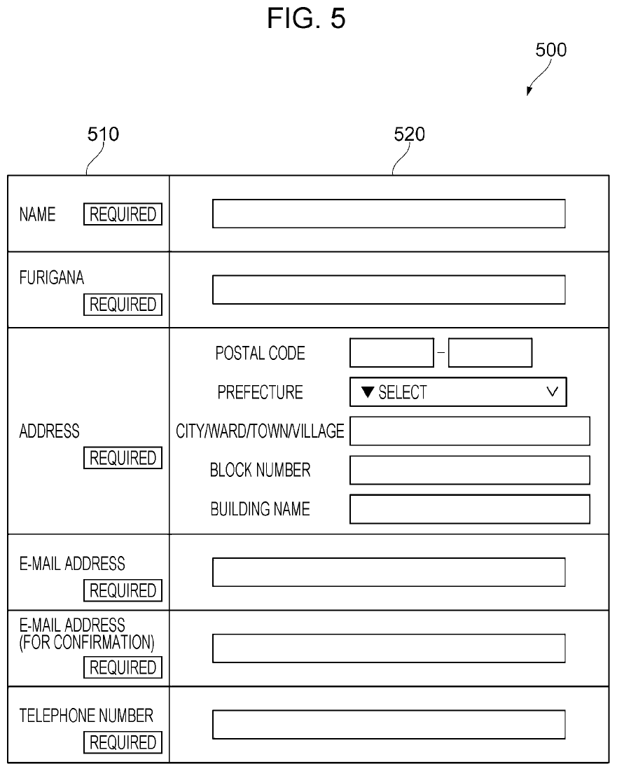

FIG. 5 illustrates a display example of a form. When the terminal apparatus 100 acquires format data of a form from the form creating server 200, the terminal apparatus 100 causes a form having a format specified by the acquired format data such as the one illustrated in FIG. 5 to be displayed, for example, on the display device 106 illustrated in FIG. 2. The form 500 illustrated in FIG. 5 has item name display columns 510 and entry columns 520. In the item name display columns 510, names of items (entry items) of information that needs to be entered in the form 500 are displayed. In the example illustrated in FIG. 5, item names “NAME”, “FURIGANA”, “ADDRESS”, “E-MAIL ADDRESS”, “E-MAIL ADDRESS (FOR CONFIRMATION)”, and “TELEPHONE NUMBER” are displayed in the item name display columns 510. In the item name display columns 510, an attribute of each item may be displayed. For example, as for an item for which entry of information is always required, an attribute “REQUIRED” indicating that entry of information is required without exception may be displayed. In the example illustrated in FIG. 5, an attribute “REQUIRED” is displayed in each of the item name display columns 510. This indicates that entry of information in all of the items illustrated in FIG. 5 is required.

In the entry columns 520, text boxes for entry of information corresponding to the respective items are displayed. In the example illustrated in FIG. 5, a single text box is prepared for each of items other than the item name “ADDRESS”. The entry column 520 corresponding to the item name “ADDRESS” further has small items “POSTAL CODE”, “PREFECTURE”, “CITY/WARD/TOWN/VILLAGE”, “BLOCK NUMBER”, and “BUILDING NAME”, and a text box is prepared for each of these small items. Among these small items, a text box of “PREFECTURE” has a message “▾SELECT” and a button “V” of a pull-down menu, so that one prefecture can be selected from the pull-down menu.

Data concerning a form sent from the form creating server 200 to the terminal apparatus 100 includes format data of the form and item data of items of the form. In the example illustrated in FIG. 5, item data indicative of the items names displayed in the item name display columns 510 is sent together with the format data of the form 500.

In a case where information corresponding to the item data is managed by the user information managing function 115, the terminal apparatus 100 that acquires format data and item data of a form and displays the form as illustrated in FIG. 5 displays the form in which the information has been entered. In the example illustrated in FIG. 5, the terminal apparatus 100 extracts information corresponding to the items displayed in the item name display columns 510 from information concerning a user and enters the extracted information in the entry columns 520 of the corresponding items.

### Example of Information Concerning User and Registration of Information

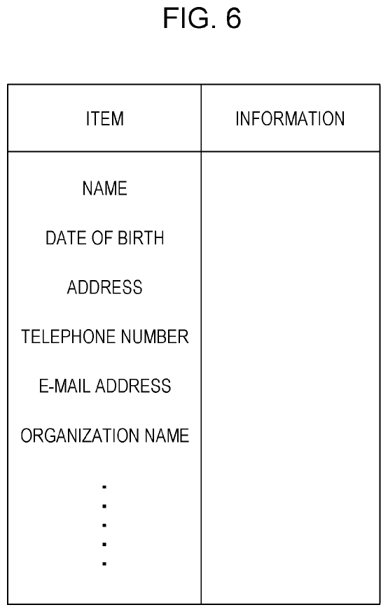

FIG. 6 illustrates an example of information managed by the user information managing function 115 of the terminal apparatus 100. As illustrated in FIG. 6, information concerning a user is correspondences between item names (“ITEMS” in FIG. 6) and information corresponding to the item names. As described above, information that is not included in the information managed by the user information managing function 115 is sometimes needs to be entered in a form. In such a case, information can be additionally registered as a target managed by the user information managing function 115.

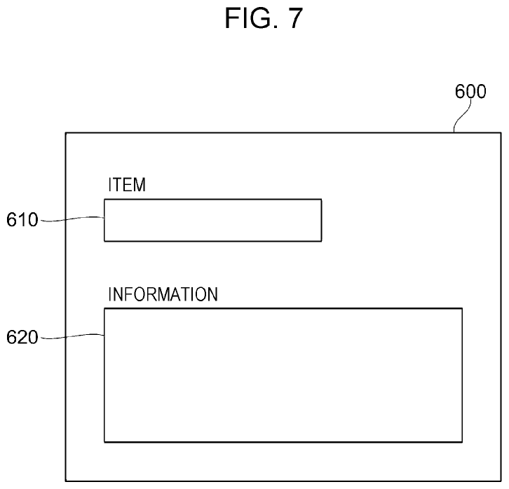

FIG. 7 illustrates an example of a registration screen for registration of information concerning a user. In a case where information to be managed by the user information managing function 115 is additionally registered, the terminal apparatus 100 causes a registration screen 600 such as the one illustrated in FIG. 7 to be displayed, for example, on the display device 106 illustrated in FIG. 2. The registration screen 600 illustrated in FIG. 7 has an item name entry part 610 and an information entry part 620. The item name entry part 610 has a text box for entry of an item name of information concerning a user to be newly registered. The information entry part 620 has a text box for entry of information corresponding to an item entered in the item name entry part 610. For example, in a case where a date of birth is newly registered as information concerning a user, an item name “DATE OF BIRTH” is entered in the text box of the item name entry part 610, and a date of birth of the user of the terminal apparatus 100 is entered in the text box of the information entry part 620.

As described above, in a case where a form is created, item data indicative of entry items in the form is sent from the form creating server 200 to the terminal apparatus 100 together with format data of the form. In a case where information concerning a user is registered on the registration screen 600, the terminal apparatus 100 may automatically enter an item name of item data acquired from the form creating server 200 in the item name entry part 610 when displaying the registration screen 600 on the display device 106. In this case, since an item name is already entered in the item name entry part 610 of the displayed registration screen 600, the user need just enter information corresponding to this item in the information input part 620.

In some cases, different names may be used as item names when information concerning a user is registered although these names have the same meaning. One example is “FULL NAME” and “NAME”. In such a case, normalization processing may be performed on item names so that item names having the same meaning or similar meanings are handled as one item in order to avoid duplicate registration of the same information under different item names. An existing normalization method used for a search engine or the like can be used for the normalization of item names.

### Scene of Creation of Form Using Terminal Apparatus 100

A scene of creation of a form using the terminal apparatus 100 in the form creating system 10 according to the first exemplary embodiment is described below. In the present exemplary embodiment, either a method that uses the code image 400 and a method that does not use the code image 400 can be employed as a method of connection of the terminal apparatus 100 to the form creating server 200. In the method that uses the code image 400, the terminal apparatus 100 connects to the form creating server 200 by using connection information read from the code image 400. As the method that does not use the code image 400, a method of connecting to the form creating server 200 by manually entering an URL of the form creating server 200 in the terminal apparatus 100 by a user or a method of connecting to the form creating server 200 by using a search service can be employed.

As described above in the description of the code image 400, by placing the code image 400 at a specific place, a connection place can be specified depending on whether or not the terminal apparatus 100 has connected to the form creating server 200 by using the code image 400. The following describes operation of the terminal apparatus 100 by using the example in which the form creating system 10 is applied to reception work used in the description of the place where the code image 400 is placed.

### Operation of Terminal Apparatus 100

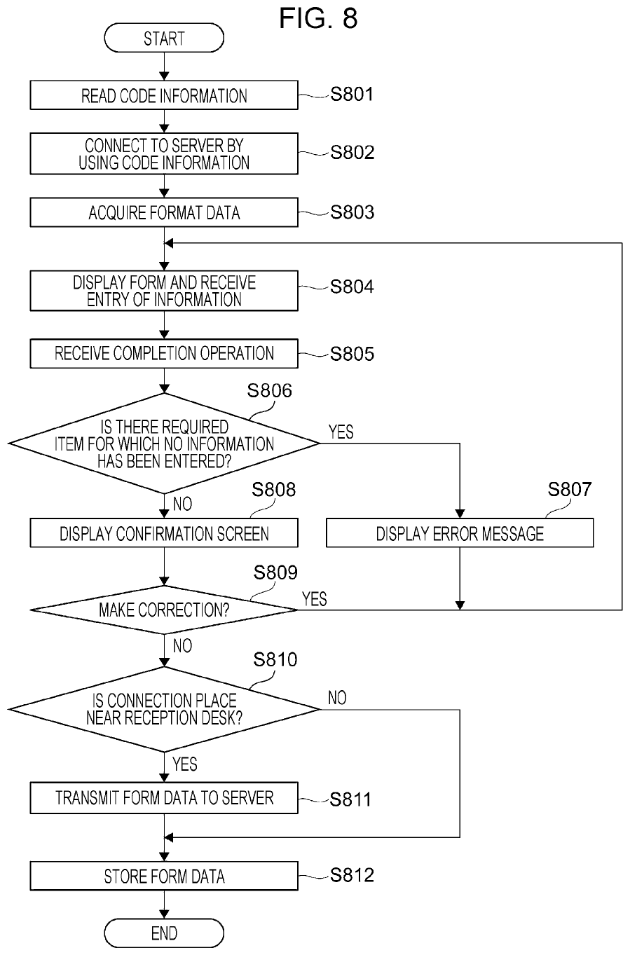

FIG. 8 is a flowchart illustrating how the terminal apparatus 100 operates when a form is created. As described above, there are a method that uses connection information of the code image 400 and a method that does not use the code image 400 as a method of connection of the terminal apparatus 100 to the form creating server 200. The following discusses a case where the terminal apparatus 100 connects to the form creating server 200 by using the code image 400. In the example in which the form creating system 10 is applied to reception work, the code image 400 is placed close to a reception desk. Accordingly, in a case where the terminal apparatus 100 connects to the form creating server 200 by using the code image 400, it is determined that the connection has been made near the reception desk.

First, a user of the terminal apparatus 100 photographs the code image 400 by using the camera 105 of the terminal apparatus 100. The terminal apparatus 100 reads code information by analyzing the code image 400 by the image analyzing function 111 (S801). Then, the terminal apparatus 100 connects to the form creating server 200 (“SERVER” in FIG. 8) by using the read code information by the form creating function 113 (S802) and acquires format data of a form from the form creating server 200 (S803). In this step, the terminal apparatus 100 acquires item data of entry items in the form from the form creating server 200 together with the format data.

Next, the terminal apparatus 100 causes the form to be displayed on the display device 106 on the basis of the acquired format data and receives entry of information in the form by the form creating function 113 and others (S804). Hereinafter, a screen on which the form is displayed is referred to as a “form creation screen”. The terminal apparatus 100 first reads out information concerning the user corresponding to the item data acquired together with the format data from the storage device 104 by the user information managing function 115. Then, the terminal apparatus 100 enters the information thus read out in an entry field of the corresponding item in the form by the form creating function 113. As a result, on the form creation screen displayed on the display device 106, the form is displayed in a manner such that information managed by the user information managing function 115 among the entry items of the form is already entered in the entry column 520 (see FIG. 5) of the corresponding item. Meanwhile, an item that is not managed by the user information managing function 115 among the entry items of the form is displayed as a blank field where no information has been entered.

The user of the terminal apparatus 100 enters information by designating an item for which no information has been entered in the form on the form creation screen displayed on the display device 106 by operating the input device 107 of the terminal apparatus 100. Furthermore, the user may change entered information by designating an item for which information has been already entered on the form creation screen. The terminal apparatus 100 receives such an operation, enters information in the designated item, and causes the entered information to be displayed in the entry column 520 of the corresponding item of the form on the form creation screen.

When entry of information in the form is completed through the above operation, the user performs a completion operation indicating that creation of the form has been completed. The completion operation may be performed, for example, by selecting a completion button displayed together with the form on the display device 106. The completion button is a button object for causing the terminal apparatus 100 to recognize that creation of the form has been completed. The completion button is selected, for example, by mouse clicking of a button object that is the completion button or touching the button object on the touch panel.

When the terminal apparatus 100 receives the user's completion operation (S805), the terminal apparatus 100 determines whether or not there is missing information. Specifically, the terminal apparatus 100 determines whether or not there is an item for which no information has not been entered among items for which entry of information is required without exception. In a case where there is a required item for which no information has been entered (YES in S806), the terminal apparatus 100 causes an error message indicating that there is a required item for which no information has been entered to be displayed on the display device 106 (S807) and returns to S804, in which the terminal apparatus 100 receives entry of information.

Meanwhile, in a case where information has been entered for all required items (NO in S806), the terminal apparatus 100 causes a confirmation screen for confirmation of the form in which information has been entered to be displayed on the display device 106 (S808). The user checks contents of the entry by referring to the confirmation screen. In a case where the user needs to correct the contents of the entry (YES in S809), the user performs an operation of returning the screen displayed on the display device 106 from the confirmation screen to the form creation screen. Upon receipt of this user's operation, the terminal apparatus 100 returns to S804, in which the terminal apparatus 100 causes the form creation screen to be displayed on the display device 106 and receives for entry for correcting information.

In a case where there is no need to correct the contents of the entry (NO in S809), the terminal apparatus 100 determines whether or not a place of connection to the form creating server 200 is a reception desk by the connection place specifying function 112. In this example, the terminal apparatus 100 has connected to the form creating server 200 by using code information read from the code image 400 as described in S801 and S802, and therefore the terminal apparatus 100 determines that the connection place is near the reception desk. Since the place of connection to the form creating server 200 is near the reception desk (YES in S810), the terminal apparatus 100 transmits the created form data to the form creating server 200 (S811) and causes the created form data to be stored in the storage device 104 (S812).

In a case where the terminal apparatus 100 has connected to the form creating server 200, for example, by manual entry of an URL without using the code image 400, the terminal apparatus 100 determines that the connection place is not near the reception desk. Since the place of connection to the form creating server 200 is not near the reception desk (NO in S810), the terminal apparatus 100 causes the created form data to be stored in the storage device 104 (S812) without transmitting the created form data to the form creating server 200.

As described above, in a case where the terminal apparatus 100 has connected to the form creating server 200 without using the code image 400, the created form data is stored in the terminal apparatus 100 without being transmitted to the form creating server 200. In this case, when the user visits the reception desk after creating the form data and connects to the form creating server 200 by using the code image 400, the form data stored in the terminal apparatus 100 is transmitted to the form creating server 200. Specifically, when the terminal apparatus 100 connects to the form creating server 200 by using code information read from the code image 400 by the operations in S801 and S802 in FIG. 8, in a case where form data that has been already created is stored in the terminal apparatus 100, the terminal apparatus 100 transmits the stored form data to the form creating server 200 without performing the operations in S803 and subsequent steps. In other words, the form data stored in the terminal apparatus 100 is transmitted to the form creating server 200 on a transmission condition that the terminal apparatus 100 has connected to the form creating server 200 by using the code image 400 in a state where form data that has been already created is stored in the terminal apparatus 100.

### Operation of Form Creating Server 200

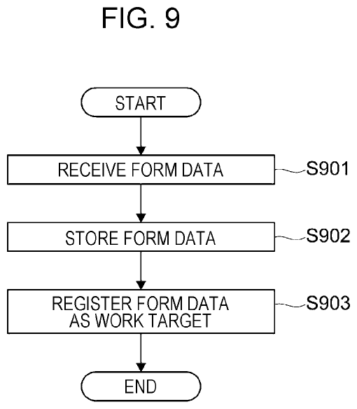

FIG. 9 is a flowchart illustrating how the form creating server 200 operates when a form is created. As an initial operation for creation of a form, the form creating server 200 reads out format data and item data from the storage device 211 upon receipt of a request to acquire format data and item data of a form from the terminal apparatus 100 and returns the format data and the item data to the terminal apparatus 100. When form data is created in the terminal apparatus 100, the created form data is transmitted from the terminal apparatus 100 to the form creating server 200.

When the form creating server 200 receives the form data (S901), the form creating server 200 causes the received form data to be stored in the form data and transfers the received form data to the work server 300, and registers the received form data as a work target (S902 and S903). The work server 300 causes forms to be displayed on a display device of a work terminal (not illustrated) used by a person in charge of the reception work in accordance with an order of registration of form data as a work target. The person in charge sequentially processes the forms displayed on the work terminal.

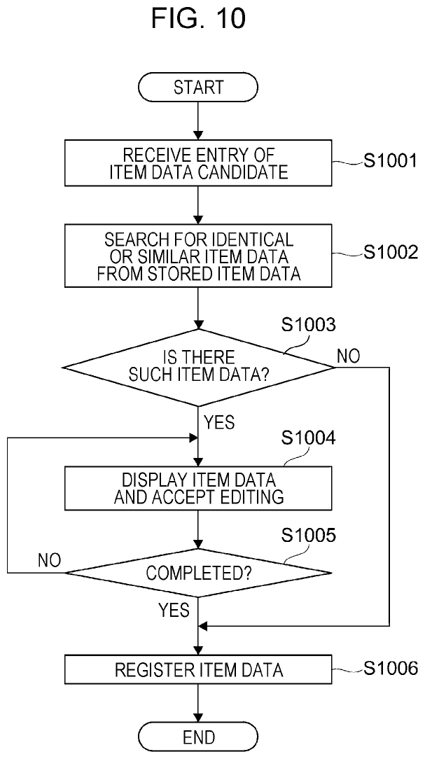

FIG. 10 is a flowchart illustrating how the form creating server 200 operates when item data is registered. In a case where format data of a form is changed or a new form is created in the form creating server 200, new item data used in the new format data is additionally registered. In a case where new item data is registered, first, a candidate for the item data is entered in the form creating server 200. The candidate for the item data is, for example, entered manually by using an administrator terminal (not illustrated) by an administrator of the form creating server 200.

When the form creating server 200 receives entry of an item data candidate (S1001), the form creating server 200 searches for item data identical or similar to the entered item data candidate among item data stored in the storage device 211 (S1002). In a case where there is no item data (“SUCH ITEM DATA” in FIG. 10) identical or similar to the entered item data candidate (NO in S1003), the form creating server 200 registers the entered item data candidate as new item data and causes the entered item data candidate to be stored in the storage device 211 (S1006).

Meanwhile, in a case where there is item data identical or similar to the item data candidate (YES in S1003), the form creating server 200 causes the entered item data candidate and the item data found by the search to be displayed on the display device of the administrator terminal and accepts administrator's editing (S1004). An editing policy of the item data can be decided specifically, for example, in accordance with specifications concerning management of item data in the form creating server 200. For example, plural item data determined as being similar may be unified as single item data or may be handled as a group of item data associated with one another.

When editing of the item data is completed, the administrator sends information indicating that editing of the item data has been completed to the form creating server 200 by operating the administrator terminal. When editing of the item data is completed, the form creating server 200 registers the edited item data and causes the edited item data to be stored in the storage device 211 (S1005 and S1006).

### Second Exemplary Embodiment

In the first exemplary embodiment, the terminal apparatus 100 acquires format data of a form from the form creating server 200 and creates a form by entering information in the acquired format data. Meanwhile, in the second exemplary embodiment, information to be entered in a form is specified and transmitted to the form creating server 200 in the terminal apparatus 100, and a form is created by using the information acquired from the terminal apparatus 100 in the form creating server 200.

### System Configuration

A configuration of a form creating system 10 according to the second exemplary embodiment is similar to the configuration of the form creating system 10 according to the first exemplary embodiment described with reference to FIG. 1. The form creating system 10 according to the second exemplary embodiment includes a terminal apparatus 100, a form creating server 200, and a work server 300. The terminal apparatus 100 can read code information from the code image 400 and connect to the form creating server 200 by using connection information included in the read code information.

### Functional Configuration of Terminal Apparatus 100

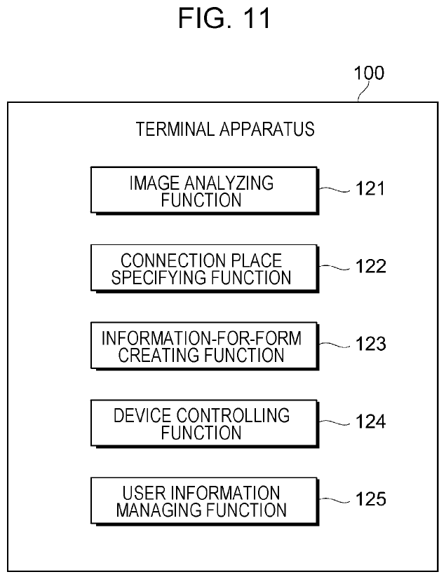

FIG. 11 illustrates a functional configuration of the terminal apparatus 100. A processor 101 illustrated in FIG. 2 executes programs, and thus the terminal apparatus 100 realizes an image analyzing function 121, a connection place specifying function 122, an information-for-form creating function 123, a device controlling function 124, and a user information managing function 125. The programs for realizing the functions of the terminal apparatus 100 are, for example, stored in a ROM 103 or a storage device 104 illustrated in FIG. 2. Among the functions illustrated in FIG. 11, the image analyzing function 121, the connection place specifying function 122, the device controlling function 124, and the user information managing function 125 are similar to the image analyzing function 111, the connection place specifying function 112, the device controlling function 114, and the user information managing function 115 of the terminal apparatus 100 according to the first exemplary embodiment described with reference to FIG. 3.

The information-for-form creating function 123 is a function of creating information for form, which is information to be entered in creation of a form. The terminal apparatus 100 acquires item data of a form from the form creating server 200 by the information-for-form creating function 123. When the terminal apparatus 100 acquires the item data, the terminal apparatus 100 creates information for form by acquiring information corresponding to items of the acquired item data, for example, from the storage device 104 illustrated in FIG. 2.

The information for form is a collection of information corresponding to the item data acquired from the form creating server 200 among information concerning a user managed by the user information managing function 125. Note that the information for form created by the terminal apparatus 100 does not necessarily include information corresponding to all of the item data acquired from the form creating server 200. In a case where information corresponding a certain piece of item data is not included in the information managed by the user information managing function 125, information corresponding to this piece of item data is not included in the information for form.

Furthermore, the terminal apparatus 100 causes the created information for form to be displayed, for example, on a display device 106 illustrated in FIG. 2 by the information-for-form creating function 123. The information for form may be displayed, for example, as a list of correspondences between item names and information. In a case where there is item data for which corresponding information is not present, information for an item name of this item data is blank. A user of the terminal apparatus 100 can enter information for an item that has no information by referring to the displayed information for form. The terminal apparatus 100 receives entry of the information and adds the entered information to the information for form by the information-for-form creating function 123. Then, the terminal apparatus 100 causes the created information for form to be stored, for example, in the storage device 104 illustrated in FIG. 2. In a case where the terminal apparatus 100 meets a predetermined transmission condition, the terminal apparatus 100 transmits the created information for form to the form creating server 200. The transmission condition will be described later.

### Configuration of Form Creating Server 200

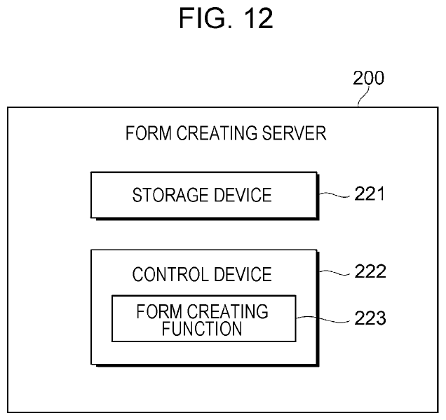

FIG. 12 illustrates a configuration of the form creating server 200. The form creating server 200 includes a storage device 221 and a control device 222. Of the functions illustrated in FIG. 12, the storage device 221 is similar to the storage device 211 of the form creating server 200 in the first exemplary embodiment described with reference to FIG. 4.

The control device 222 reads out item data of a form from the storage device 221 and transmits the item data to the terminal apparatus 100 in response to a request from the terminal apparatus 100. Furthermore, the control device 222 of the form creating server 200 according to the second exemplary embodiment includes a form creating function 223. The control device 222 receives created information for form from the terminal apparatus 100 and creates a form by using the received information for form by the form creating function 223. Then, the control device 222 transmits data of the created form to the work server 300. The control device 222 may cause the data of the created form to be stored in the storage device 221.

The form creating function 223 is a function of creating a form by using a blank form acquired from the form creating server 200. The form creating server 200 reads out format data of a form from the storage device 221 by the form creating function 223. The form creating server 200 creates a form by entering information for form acquired from the terminal apparatus 100 in the format data thus read out.

### Scene of Creation of Information for Form

A scene of creation of a form by the form creating system 10 according to the second exemplary embodiment is described. In the present exemplary embodiment, a form is created in the form creating server 200 by using information for form created by the terminal apparatus 100. Meanwhile, the information for form is created in the terminal apparatus 100. Furthermore, the terminal apparatus 100 transmits the information for form to the form creating server 200 when the terminal apparatus 100 connects to the form creating server 200 by using a code image 400.

Also in the second exemplary embodiment, either a method that uses the code image 400 and a method that that does not use the code image 400 can be employed as a method of connection of the terminal apparatus 100 to the form creating server 200. In the method that uses the code image 400, the terminal apparatus 100 connects to the form creating server 200 by using connection information read from the code image 400. As the method that does not use the code image 400, a method of connecting to the form creating server 200 by user's manual entry of an URL of the form creating server 200 in the terminal apparatus 100 or by using a search service can be employed.

In the first exemplary embodiment, a connection place can be specified depending on whether or not the terminal apparatus 100 has used the code image 400 to connect to the form creating server 200 by placing the code image 400 at a specific place, as described in the description of the code image 400 that. The following describes operation of the terminal apparatus 100 by using the example in which the form creating system 10 is applied to reception work used in the description of the place where the code image 400 is placed in the first exemplary embodiment.

### Operation of Terminal Apparatus 100

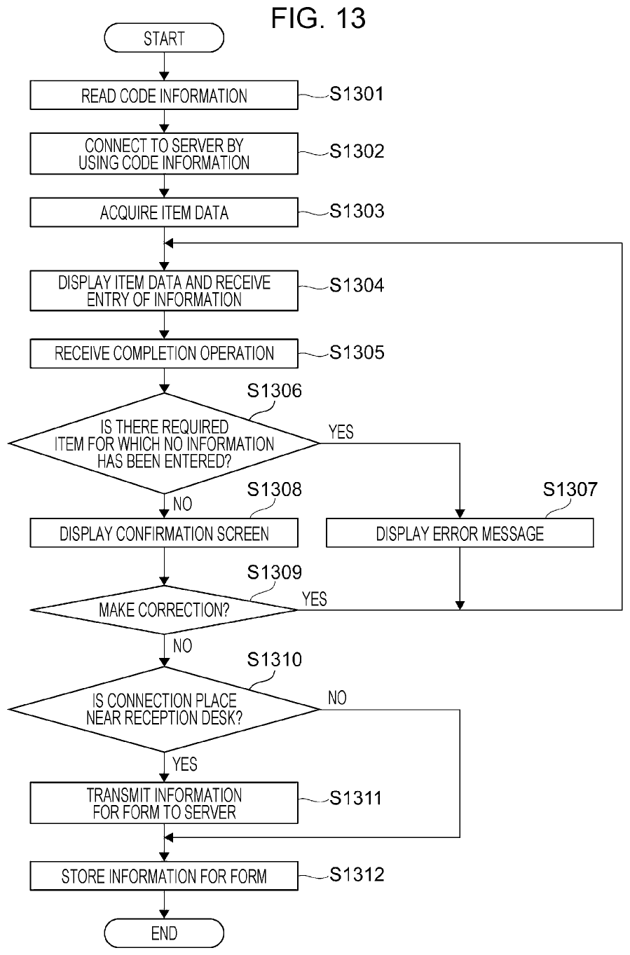

FIG. 13 is a flowchart illustrating how the terminal apparatus 100 operates when information for form is created. As described above, there are a method that uses connection information of the code image 400 and a method that does not use the code image 400 as a method of connection of the terminal apparatus 100 to the form creating server 200. The following assumes that the terminal apparatus 100 connects to the form creating server 200 by using the code image 400. In the example in which the form creating system 10 is applied to reception work, the code image 400 is placed close to a reception desk. Accordingly, in a case where the terminal apparatus 100 connects to the form creating server 200 by using the code image 400, it is determined that the connection has been made near the reception desk.

First, a user of the terminal apparatus 100 photographs the code image 400 by using the camera 105 of the terminal apparatus 100. The terminal apparatus 100 reads code information by analyzing the code image 400 by the image analyzing function 121 (S1301). Then, the terminal apparatus 100 connects to the form creating server 200 (“SERVER” in FIG. 13) by using the read code information by the information-for-form creating function 123 (S1302) and acquires item data of a form from the form creating server 200 (S1303).

Next, the terminal apparatus 100 causes the acquired item data to be displayed on the display device 106 and receives entry of information corresponding to items by the information-for-form creating function 123 and others (S1304). The terminal apparatus 100 first reads out, from the storage device 104, information concerning the user corresponding to the item data acquired from the form creating server 200 by the user information managing function 125. Then, the terminal apparatus 100 causes a screen for creation of information for form including the information read out from the storage device 104 to be displayed on the display device 106 by the information-for-form creating function 123. On this screen, the information may be displayed, for example, in a list of correspondences between the read information and items. In a case where information corresponding to a certain item is not stored in the storage device 104, no information is displayed for this item.

The user of the terminal apparatus 100 enters information by designating an item for which no information has been entered in information for form displayed on the display device 106 by operating an input device 107 of the terminal apparatus 100. Furthermore, the user may designate an item for which information has been already entered and change this information on the screen for creation of information for form. The terminal apparatus 100 receives such an operation, enters information corresponding the designated item, and displays the entered information together with the item.

When entry of the information for form is completed through the above operations, the user performs a completion operation indicating that entry of information has been completed. The completion operation may be, for example, performed by selecting a completion button displayed together with the form on the display device 106.

When the terminal apparatus 100 receives the user's completion operation (S1305), the terminal apparatus 100 determines whether or not there is missing of information to be entered. Specifically, the terminal apparatus 100 determines whether or not there is an item for which no information has been entered among items for which entry of information is required. In a case where there is a required item for which no information has been entered (YES in S1306), the terminal apparatus 100 causes an error message indicating that there is a required item for which no information has been entered to be displayed on the display device 106 (S1307) and returns to S1304, in which the terminal apparatus 100 receives entry of information.

Meanwhile, in a case where information has been entered for all required items (NO in S1306), the terminal apparatus 100 causes a confirmation screen for confirmation of the information to be displayed on the display device 106 (S1308). The confirmation screen can be, for example, a list of correspondences between items and information. The user checks contents of the entry by referring to the confirmation screen. In a case where the user needs to correct the contents of the entry (YES in S1309), the user performs an operation of returning the screen displayed on the display device 106 from the confirmation screen to the screen for creation of information for form. Upon receipt of this user's operation, the terminal apparatus 100 returns to S1304, in which the terminal apparatus 100 causes the screen for creation of information for form to be displayed on the display device 106 and receives entry for correcting information.

In a case where there is no need to correct the contents of the entry (NO in S1309), the terminal apparatus 100 determines whether or not a place of connection to the form creating server 200 is a reception desk by the connection place specifying function 122. In this example, the terminal apparatus 100 has connected to the form creating server 200 by using code information read from the code image 400 as described in S1301 and S1302, and therefore the terminal apparatus 100 determines that the connection place is near the reception desk. Since the place of connection to the form creating server 200 is near the reception desk (YES in S1310), the terminal apparatus 100 transmits the created information for form to the form creating server 200 (S1311) and causes the created information for form to be stored in the storage device 104 (S1312).

In a case where the terminal apparatus 100 has connected to the form creating server 200, for example, by manual entry of an URL without using the code image 400, the terminal apparatus 100 determines that the connection place is not near the reception desk. Since the place of connection to the form creating server 200 is not near the reception desk (NO in S1310), the terminal apparatus 100 causes the created information for form to be stored in the storage device 104 (S1312) without transmitting the created information for form to the form creating server 200.

As described above, in a case where the terminal apparatus 100 has connected to the form creating server 200 without using the code image 400, the created information for form is stored in the terminal apparatus 100 without being transmitted to the form creating server 200. In this case, when the user visits the reception desk after creating the form data and connects to the form creating server 200 by using the code image 400, the information for form stored in the terminal apparatus 100 is transmitted to the form creating server 200. Specifically, when the terminal apparatus 100 connects to the form creating server 200 by using code information read from the code image 400 by the operations in S1301 and S1302 in FIG. 13, in a case where information for form that has been already created is stored in the terminal apparatus 100, the terminal apparatus 100 transmits the stored information for form to the form creating server 200 without performing the operations in S1303 and subsequent steps. In other words, the information for form stored in the terminal apparatus 100 is transmitted to the form creating server 200 on a transmission condition that the terminal apparatus 100 has connected to the form creating server 200 by using the code image 400 in a state where information for form that has been already created is stored in the terminal apparatus 100.

### Operation of Form Creating Server 200

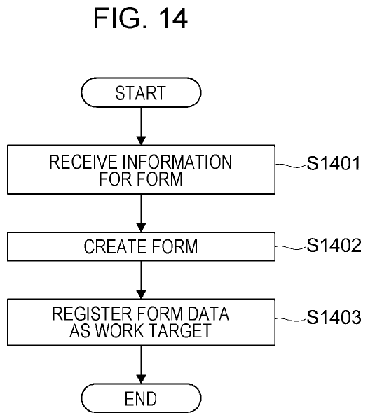

FIG. 14 is a flowchart illustrating how the form creating server 200 operates when a form is created. As an initial operation for creation of a form, the form creating server 200 reads out item data from the storage device 221 upon receipt of a request to acquire the item data of the form from the terminal apparatus 100 and returns the item data to the terminal apparatus 100. When information for form is created in the terminal apparatus 100, the created information for form is transmitted from the terminal apparatus 100 to the form creating server 200.

When the form creating server 200 receives information for form from the terminal apparatus 100 (S1401), the form creating server 200 reads out format data of the form from the storage device 221 and creates the form by entering the information for form acquired from the terminal apparatus 100 in the format data thus read out (S1402). Then, the form creating server 200 stores the created form in the storage device 221, transfers the created form to the work server 300, and registers the created from as a work target (S1403). The work server 300 causes forms to be displayed on a display device of a work terminal (not illustrated) used by a person in charge of the reception work in accordance with an order of registration of form data as a work target. The person in charge sequentially processes the forms displayed on the work terminal.

Although the exemplary embodiments of the present disclosure have been described, the technical scope of the present disclosure is not limited to the above exemplary embodiments. For example, in the above exemplary embodiments, a method for specifying a place where the terminal apparatus 100 has connected to the form creating server 200 on the basis of a place where the code image 400 is placed has been mainly described. In addition, various positioning systems and a method for recording information concerning a place on the code image 400 can be employed, as described above. Furthermore, reading of the code image 400 as a form transmission condition and a method for specifying a connection place may be separated. Specifically, for example, an indoor positioning system or the like may be used to specify a connection place, and in a case where the terminal apparatus 100 connects to the form creating server 200 by reading the code image 400, created form data or information for form may be transmitted to the form creating server 200. In this way, for example, even in a case where it is determined that the terminal apparatus 100 has connected to the form creating server 200 at a specific place, for example, near a reception desk, transmission and non-transmission of form data and information for form can be controlled in accordance with whether or not the terminal apparatus 100 has connected to the form creating server 200 by using the code image 400. In addition, various changes or replacement of a configuration that are not departed from the scope of the technical idea of the present disclosure are encompassed within the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A form creating system comprising:
a terminal apparatus that creates a form; and
a server that receives transmission of the form from the terminal apparatus,
wherein:
the server transmits, to the terminal apparatus and in response to a request from the terminal apparatus, format data of the form to which item data indicative of a necessary entry item of information concerning a user is added; and
the terminal apparatus stores the information concerning the user in a storage device of the terminal apparatus in association with the item data, creates the form by entering, in an entry field associated with the item data in the format data, information corresponding to the item data added to the format data received from the server among the information concerning the user stored in the terminal apparatus, and transmits the created form to the server.

2. The form creating system according to claim 1, wherein:
the terminal apparatus has a function of specifying a place where the terminal apparatus is connected to the server;
in a case where the terminal apparatus creates the form by connecting to the server at a predetermined specific place, the terminal apparatus transmits the created form to the server; and
in a case where the terminal apparatus creates the form by connecting to the server at a place other than the specific place, the terminal apparatus does not transmit the created form to the server.

3. The form creating system according to claim 2, wherein:
the terminal apparatus includes a reading unit that reads a code recorded on a code image; and
the terminal apparatus transmits the created form to the server in a case where the terminal apparatus has connected to the server by using a code read from a code image placed at the specific place by the reading unit.

4. The form creating system according to claim 2, wherein:
the terminal apparatus causes the created form to be stored in the storage device in a case where the terminal apparatus creates the form by connecting to the server at the place other than the specific place.

5. The form creating system according to claim 3, wherein:
the terminal apparatus causes the created form to be stored in the storage device in a case where the terminal apparatus creates the form by connecting to the server at the place other than the specific place.

6. The form creating system according to claim 4, wherein:
the terminal apparatus transmits the stored form to the server in a case where the form created by connecting to the server at the place other than the specific place is stored in the terminal apparatus when the terminal apparatus connects to the server at the specific place.

7. The form creating system according to claim 5, wherein:
the terminal apparatus transmits the stored form to the server in a case where the form created by connecting to the server at the place other than the specific place is stored in the terminal apparatus when the terminal apparatus connects to the server at the specific place.

8. The form creating system according to claim 1, wherein:
the terminal apparatus includes an input unit used by a user to enter information concerning the user; and
in a case where the information concerning the user stored in the terminal apparatus does not include information corresponding to the item data added to the format data, the terminal apparatus receives entry of information by the input unit and enters the entered information in an entry field associated with the item data in the format data.

9. The form creating system according to claim 8, wherein:
the terminal apparatus causes the information corresponding to the item data entered by the user to be stored in the storage device in association with the item data.

10. A form creating system comprising:
a terminal apparatus that stores therein information concerning a user; and
a server that creates a form by acquiring the information concerning the user for a form from the terminal apparatus,
wherein:
the server transmits item data indicative of an entry item of information necessary for creation of the form to the terminal apparatus in response to a request from the terminal apparatus; and
the terminal apparatus stores therein the information concerning the user in association with the item data, extracts information corresponding to the item data received from the server among the information concerning the user stored in the terminal apparatus, causes the extracted information to be stored in a storage device of the terminal apparatus as the information concerning the user for the form, and transmits the information concerning the user for the form to the server in a case where a predetermined transmission condition is met.

11. The form creating system according to claim 10, wherein:
the terminal apparatus has a function of specifying a place where the terminal apparatus is connected to the server;
in a case where the terminal apparatus has acquired the item data by connecting to the server at a predetermined specific place, the terminal apparatus meets the transmission condition and transmits the information concerning the user for the form based on the item data to the server; and
in a case where the terminal apparatus has acquired the item data by connecting to the server at a place other than the specific place, the terminal apparatus does not transmit the information concerning the user for the form based on the item data to the server.

12. The form creating system according to claim 10, wherein:
the terminal apparatus includes an input unit used by a user to enter information concerning the user; and
in a case where the information concerning the user stored in the terminal apparatus does not include information corresponding to the item data, the terminal apparatus receives entry of information by the input unit and causes the entered information to be entered in an entry field associated with the item data.

13. The form creating system according to claim 12, wherein:
the terminal apparatus causes the information corresponding to the item data entered by the user to be stored in the storage device in association with the item data.

14. A non-transitory computer readable medium storing a program causing a computer to execute a process, the process comprising:
storing, in a storage device, information concerning a user and item data classifying the information concerning the user in association with each other;
acquiring format data of a form;
extracting item data from the acquired format data;
reading out, from the storage device, information corresponding to the extracted item data among the information concerning the user stored in the storage device on the basis of the extracted item data; and
creating the form by entering the information thus read out in an entry field associated with the item data in the format data.

15. The non-transitory computer readable medium according to claim 14, wherein:
the process further comprises:
specifying a place where the format data is acquired;
transmitting the created form to a specific external apparatus and causing the form to be stored in the storage device in a case where the format data has been acquired at a predetermined specific place; and
causing the created form to be stored in the storage device without transmitting the created form to the external apparatus in a case where the format data has been acquired at a place other than the specific place.

16. The non-transitory computer readable medium according to claim 15, wherein:
the process further comprises transmitting the created form to a server in a case where the format data has been acquired by using information obtained by reading a code image placed at the specific place.

17. The non-transitory computer readable medium according to claim 15,
the process further comprises transmitting the stored form to a server in a case where the form created by using format data identical to the format data is stored in the storage device when the format data is acquired at the specific place.

18. The non-transitory computer readable medium according to claim 14,
the process further comprises receiving user's entry of information corresponding to the item data and entering the entered information in an entry field associated with the item data in the format data in a case where the information concerning the user stored in the storage device does not include information corresponding to the item data added to the format data.

19. The non-transitory computer readable medium according to claim 18,
the process further comprises causing the information corresponding to the item data entered by the user to be stored in the storage device in association with the item data.
